(19) United States
(12) Patent Application Publication
(10) Pub. No.: US 2015/0340172 A1
(43) Pub. Date: Nov. 26, 2015

(54) MESOPOROUS CARBON COMPOSITE MATERIAL, PRODUCTION METHODS THEREOF, AND ELECTRONIC DEVICE INCLUDING THE SAME

(71) Applicant: SAMSUNG ELECTRONICS CO., LTD., Suwon-si (KR)

(72) Inventors: Hyo Rang KANG, Anyang-si (KR); Jeong Hyeon KIM, Suwon-si (KR); Ji Mam KIM, Suwon-si (KR); Chan Ho PAK, Yongin-si (KR)

(21) Appl. No.: 14/717,534

(22) Filed: May 20, 2015

(30) Foreign Application Priority Data
May 20, 2014 (KR) 10-2014-0060545
May 20, 2015 (KR) 10-2015-0070448

(51) Int. Cl. H01G 11/42; C02F 1/469; H01G 11/86

(52) U.S. Cl. CPC H01G 11/42; H01G 11/86; C02F 1/4691; C02F 2201/46

(57) ABSTRACT

A mesoporous carbon composite material includes mesoporous carbon, metal nanoparticles distributed on the mesoporous carbon, and phosphorus on the mesoporous carbon. An electronic device includes an electrode including the mesoporous carbon composite material. A method of producing a mesoporous carbon composite metal includes impregnating mesoporous silica with a carbon precursor solution, forming a carbon silica composite by heat-treating the mesoporous silica impregnated with the carbon precursor solution, and removing silica from the carbon silica composite. The carbon precursor solution includes a phosphorous-containing carbon precursor, a metal-containing salt, a solvent, and optionally a carbonization catalyst.

### RELATED APPLICATIONS

This application claims priority under 35 U.S.C. §119 to Korean Patent Application No. 10-2014-0060545, filed in the Korean Intellectual Property Office on May 20, 2014, and Korean Patent Application No. 10-2015-0070448, filed in the Korean Intellectual Property Office on May 20, 2015 the entire contents of which are incorporated herein by reference.

### BACKGROUND

1. Field

A mesoporous carbon composite material, production methods thereof, and an electronic device including the same are disclosed.

2. Description of Related Art

As various electronic devices are being down-sized and weight-reduced, and as electric vehicles are becoming more popular, energy storage devices have been actively researched to accomplish high energy density and improved power density. Examples of the energy storage device may include a high performance rechargeable battery, a super-capacitor, and the like. The electrode material may have a significant impact on capacity and energy (or powder) density of the energy storage device, so it is desirable to develop technologies for improving the performance of the electrode material.

On the other hand, a capacitive deionization (CDI) apparatus such as a flow-through capacitor, which is energy efficient and convenient, may remove a dissolved solid (e.g., an ionic material) from a fluid such as water in an environmentally friendly way. An electrode material capable of providing high capacitance may provide a capacitive deionization apparatus having improved ion adsorption capability and deionization performance.

### SUMMARY

Example embodiments relate to a carbon composite material providing an electrode capable of showing improved performance.

Example embodiments relate to a method of producing the carbon composite material.

Example embodiments relate to an electronic device including the electrode material.

According to example embodiments, a mesoporous carbon composite material includes mesoporous carbon, a plurality of metal nanoparticles distributed on the mesoporous carbon, and phosphorus (P) on the mesoporous carbon.

In example embodiments, the mesoporous carbon may be ordered mesoporous carbon.

In example embodiments, the metal may include one of copper (Cu), tin (Sn), zinc (Zn), titanium (Ti), silver (Ag), palladium (Pd), and a combination thereof.

In example embodiments, the metal nanoparticles may have an average particle size of less than or equal to about 90 nm.

In example embodiments, the metal nanoparticle may have an average particle size of less than or equal to about 70 nm.

In example embodiments, the amount of the metal nanoparticles may be about 3 to about 45 parts by weight based on 100 parts by weight of the mesoporous carbon.

In example embodiments, the amount of the phosphorus may be about 1 to about 20 parts by weight based on 100 parts by weight of the mesoporous carbon.

In example embodiments, the composite material may have an average pore diameter of less than or equal to about 10 nm, and may have a total pore volume of less than or equal to about 1.5 cm³/g.

In example embodiments, the composite material may have capacitance of greater than or equal to about 200 F/g at a scan rate of 10 mV/s.

In example embodiments, the composite material may have capacitance of greater than or equal to about 230 F/g at a scan rate of 10 mV/s.

According to example embodiments, a method of producing a mesoporous carbon composite material including mesoporous carbon, a plurality of metal nanoparticles distributed on the mesoporous carbon, and phosphorus on the mesoporous carbon includes: preparing a carbon precursor solution including a phosphorus-containing carbon precursor, a metal-containing salt, a solvent, and optionally a carbonization catalyst; impregnating a mesoporous silica with the carbon precursor solution; forming a carbon-silica composite by heat-treating the mesoporous silica impregnated with the carbon precursor solution; and removing silica from the carbon silica composite.

In example embodiments, the mesoporous carbon material may include ordered mesoporous carbon.

In example embodiments, the carbon precursor solution may further include a carbon precursor without phosphorus.

In example embodiments, the phosphorus-containing carbon precursor may include one of a phosphorus-containing aliphatic or aromatic hydrocarbon, a carbon-phosphorus-containing heterocyclic compound, a phosphorus-containing carbohydrate, and a combination thereof.

In example embodiments, the metal-containing salt may be a salt including one of copper (Cu), tin (Sn), zinc (Zn), titanium (Ti), silver (Ag), palladium (Pd), and a combination thereof.

In example embodiments, the carbonization catalyst may be one of an organic acid and an inorganic acid.

In example embodiments, the carbon precursor solution may include the metal-containing salt in an amount to provide the metal nanoparticles at about 3 to about 45 parts by weight based on 100 parts by weight of the mesoporous carbon in the mesoporous carbon composite material.

In example embodiments, the carbon precursor solution may include the phosphorus-containing carbon precursor in an amount to provide phosphorus at greater than or equal to about 1 part by weight based on 100 parts by weight of the mesoporous carbon in the mesoporous carbon composite material.

In example embodiments, the heat treatment may include drying the impregnated mesoporous silica and carbonizing the carbon precursor solution.

In example embodiments, the removing silica from the carbon-silica composite may include contacting a solvent capable of selectively dissolving silica with the carbon-silica composite.

According to example embodiments, an electronic device includes an electrode including a mesoporous carbon composite material including mesoporous carbon, a plurality of metal nanoparticles distributed on the mesoporous carbon, and phosphorus on the mesoporous carbon.

In example embodiments, the electronic device may include a cathode, an anode, and an electrolyte interposed between the anode and the cathode, wherein at least one of the cathode and the anode may include the aforementioned electrode.

In example embodiments, the electrolyte may include a halogen-containing salt.

In example embodiments, the electronic device may be an energy storage device or a capacitive deionization apparatus.

In example embodiments, the aforementioned composite material may show not only an electric double layer capacitance but also pseudocapacitance based on Faraday reaction. Therefore, when being used as an electrode material, it may realize high capacitance and thus may improve a capacity of an energy storage device. In addition, such a high capacitance may further decrease a volume of the energy storage device and the device including the same may omit some parts such as a current collector, a separator, and the like and thus have a decreased size.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other features of inventive concepts will be apparent from the more particular description of non-limiting embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a view schematically showing a production method according to example embodiments.

FIG. 2 is a schematic view showing a cross-section of a device according to example embodiments.

FIG. 3 is a table showing amounts of raw materials used for preparing the composite materials of a reference example and Comparative Examples 3 and 6 to 12.

FIG. 4 shows CV results of Experimental Example 1.

FIG. 5 shows an X-ray diffraction spectrum according to Experimental Example 2.

FIG. 6 shows CV results of Experimental Example 3.

FIG. 7 shows CV results of Experimental Example 4.

FIG. 8 shows scanning electron microscope images of the composite material of Comparative Example 4 in Experimental Example 5.

FIG. 9 shows scanning electron microscope images of the composite material according to Example 2 in Experimental Example 5.

FIG. 10 is a graph showing a size distribution of copper particles in the carbon composite material of Comparative Example 4 in Experimental Example 5.

FIG. 11 is a graph showing a size distribution of copper particles in the carbon composite material of Example 2 in Experimental Example 5.

FIG. 12 is a graph showing a size distribution of copper particles in the carbon composite material of Example 5 in Experimental Example 5.

FIG. 13 is X-ray diffraction spectrum of carbon composite materials of Comparative Example 4 and Examples 2 and 5 in Experimental Example 5.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted. Well-known process technologies may not explained in detail in order to avoid obscuring details of example embodiments.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. Further, the singular includes the plural unless mentioned otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

If not defined otherwise, all terms (including technical and scientific terms) in the specification may be defined as commonly understood by one skilled in the art. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

As used herein, the term “capacitive deionization apparatus” refers to a device that may separate and/or concentrate ions by passing fluids to be separated or to be concentrated including at least one ion component through a flow path formed between at least one pair of deionization electrodes and applying a voltage thereto so as to adsorb the ion components on fine pores in the electrodes. The “capacitive deionization apparatus” may have any geometric structure.

In example embodiments, a carbon composite material includes mesoporous carbon, metal nanoparticles distributed on the mesoporous carbon, and phosphorus (e.g., on the mesoporous carbon). The mesoporous carbon may be ordered mesoporous carbon. Whether the mesoporous carbon is “ordered” may be determined by appropriate analytical methods. The metal may include copper (Cu), tin (Sn), zinc (Zn), titanium (Ti), silver (Ag), palladium (Pd), or a combination thereof. The metal nanoparticles may have an average particle size of less than or equal to about 90 nm, for example, of less than or equal to about 70 nm, or of less than or equal to about 60 nm. The metal nanoparticles may have an average particle size of greater than or equal to about 1 nm. The amount of the metal nanoparticles may be greater than or equal to about 3 parts by weight, for example, greater than or equal to about 5 parts by weight, or greater than or equal to about 10 parts by weight, based on 100 parts by weight of carbon. The metal nanoparticles of the aforementioned amount may accelerate a faradaic electrochemical reaction via an oxidation-reduction reaction, intercalation, an electrosorption, or the like when it is present together with phosphorus (P), which will be described below. The amount of the metal nanoparticles may be less than or equal to 45 parts by weight, for example, less than or equal to 40 parts by weight, less than or equal to 38 parts by weight, less than or equal to 35 parts by weight, less than or equal to 30 parts by weight, or less than or equal to 25 parts by weight, based on 100 parts by weight of carbon. The metal nanoparticles of the aforementioned amount may be dispersed (or distributed) on mesoporous carbon without causing damage to a structure of the carbon composite material.

The amount of the phosphorus may be greater than or equal to about 1 part by weight, for example, greater than or equal to about 5 parts by weight, greater than or equal to about 6 parts by weight, greater than or equal to about 7 parts by weight, greater than or equal to about 8 parts by weight, greater than or equal to about 9 parts by weight, or greater than or equal to about 10 parts by weight, based on 100 parts by weight of carbon. The phosphorus of the aforementioned amount may help disperse the metal as a nanoparticle, thereby enhancing the activity of the metal to facilitate a faradaic electrochemical reaction. The amount of the phosphorus may be less than or equal to 20 parts by weight based on 100 parts by weight of carbon. When using a phosphorus-containing carbon precursor, which will be described later, the obtained carbon composite may include phosphorus in the aforementioned amount.

The composite material may have a specific surface area of greater than or equal to about 500 cm²/g, for example, greater than or equal to about 550 cm²/g, or greater than or equal to about 610 cm²/g. The carbon composite material may have, for example, a specific surface area of less than or equal to about 750 cm²/g, less than or equal to about 700 cm²/g, or less than or equal to about 690 cm²/g. The carbon composite material may have an average pore diameter of, for example, greater than or equal to about 2.0 nm, greater than or equal to about 2.5 nm, or greater than or equal to about 3.0 nm. The carbon composite material may have an average pore diameter of less than or equal to about 11 nm, for example, less than or equal to about 10 nm, less than or equal to about 9 nm, less than or equal to about 8 nm, less than or equal to about 7 nm, less than or equal to about 6 nm, or less than or equal to about 5 nm. The carbon composite material may have a total pore volume, for example, of less than or equal to about 1.5 cm³/g. When having the aforementioned structural properties, the metal nanoparticle dispersed on the mesoporous carbon may undergo the faradaic electrochemical reaction more smoothly.

The electrode material based on the carbon material of a high specific surface area such as activated carbon may show performance based on the electric double layer capacitance (EDLC). In this case, the storage principle is electrostatic storage accomplished by separating charges in the Helmholtz double layer on the interface between the conductive electrode surface and the electrolyte, which may be governed by the following equation.

$$C = {ɛ}_{o} ɛ \frac{A}{d}$$

C: capacitance
εₒ: Vacuum permittivity
ε: permittivity
A: electrode plate surface area
d: a distance between the electrode plates

The capacitance accomplished by the principle is generally about 120 to about 200 F/g.

On the other hand, the carbon composite material may further have the following pseudocapacitance besides the electric double layer capacitance. In the pseudocapacitance, the chemical species (e.g., halogen ions) included in electrolyte is electrosorpted onto the metal nanoparticles to cause intercalation and faradaic electrochemical storage by, for example, the oxidation-reduction reaction as follows.

Cl⁻ₛₒₗ+metal<->metal-Cl_{adduct}+e_{M}

In the formula, the metal is Cu, Sn, Zn, Ti, Ag, or Pd.

Unlike the electric double layer capacitance, the pseudocapacitance may be governed by the following equation.

$$c = \frac{qF}{RT} θ ( 1 - θ )$$

c: capacitance
R: gas constant
T: absolute temperature
F: faraday constant
q: the number of electrons passed
θ: surface coverage ratio

Accordingly, the carbon composite material may have a significantly higher capacity (greater than or equal to about 200 F/g, for example, greater than or equal to about 250 F/g) than that of the conventional carbon material having a high surface area, for example, an activated carbon. According to example embodiments, the composite material may have electrostatic capacity of greater than or equal to about 200 F/g at a scan rate of 10 mV/s, for example, greater than or equal to about 230 F/g.

As the composite material has such high capacity, the energy storage device including the same may have improved capacity and may have a significantly decreased volume (e.g. decreased by at least about 30%) compared to the device including the generally-used carbon electrode material while having the equivalent level of capacity. In addition, based on the aforementioned faradaic storage principle, use of a current collector or a separator and the like may be omitted or reduced, so the total production cost of an energy storage device may be reduced.

In example embodiments, the carbon composite material may be prepared in accordance with the following method. According to example embodiments, a method of producing the carbon composite material includes: providing mesoporous silica; preparing a carbon precursor solution including a phosphorus-containing carbon precursor, a metal-containing salt, optionally a carbonization catalyst, and a solvent; impregnating the mesoporous silica with the carbon precursor solution; heat-treating the mesoporous silica impregnated with the carbon precursor solution to obtain a carbon-silica composite; and removing silica from the carbon silica composite to obtain the mesoporous carbon composite material.

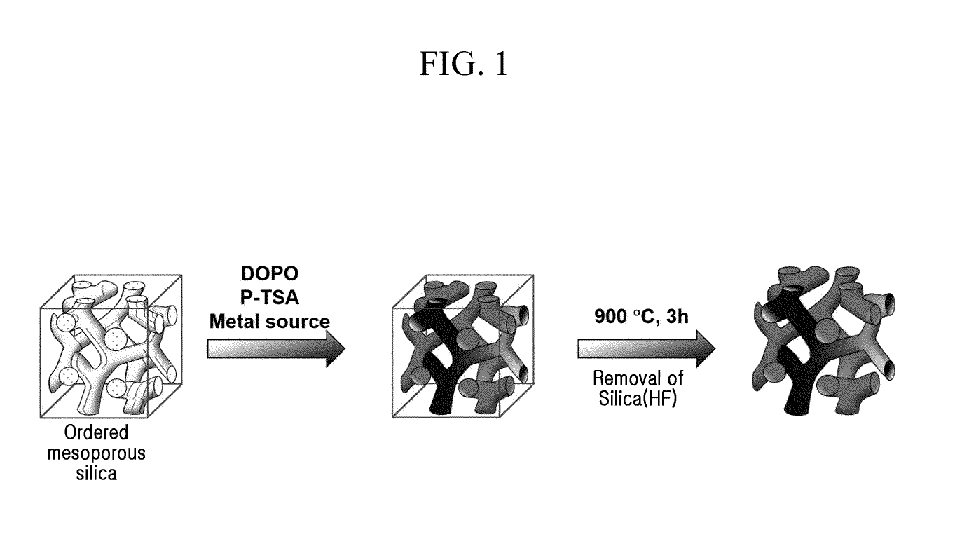

FIG. 1 is a schematic view showing a production method according to example embodiments. In FIG. 1, a mesoporous silicate (e.g., KIT-6) is impregnated with a solution including a carbon precursor and a metal salt to fill mesopores of the mesoporous silicate with the solution and is then dried/carbonized, and then silica is removed to provide a composite material having a similar structure to the structure of the original silica template.

The mesoporous silica may be porous silica having an average pore size of about 2 to about 30 nm. The mesoporous silica may be ordered mesoporous silica. The mesoporous silica may play a role of a template for providing a mesoporous carbon in the method. The mesoporous silica may be synthesized according to a known method or may be commercially available in the market. Examples of the mesoporous silica may include MCM-based silica such as MCM-41, MCM-48, or MCM-50; SBA-X-based silica such as SBA-3, SBA-5, SBA-15, or SBA-16; MSU-X-based silica; and KIT-X-based silica such as KIT-1, KIT-5, or KIT-6, but are not limited thereto. The silica may include a mesoporous and inter-penetrating network having a substantially uniform diameter. The mesoporous silica particle size is not particularly limited and may be selected appropriately. For example, the mesoporous silica particle may have an average size of greater than or equal to about 10 nm, greater than or equal to about 20 nm, greater than or equal to about 30 nm, greater than or equal to about 40 nm, greater than or equal to about 50 nm, or greater than or equal to about 60 nm, but it is not limited thereto. For example, the mesoporous silica particle may have an average size of less than or equal to about 10 μm.

The carbon precursor solution includes a phosphorus-containing carbon precursor compound, a metal-containing salt, optionally a carbonization catalyst, and a solvent. If desired, the carbon precursor solution may further include a carbon precursor compound that does not include phosphorus.

Herein, the term “the carbon precursor compound” means a compound capable of providing a material consisted of carbon (e.g., graphite, amorphous carbon, or the like) by pyrolysis. The phosphorus-containing carbon precursor compound may include a phosphorus-containing organic compound. The phosphorus-containing organic compound may be, for example, a phosphorus-containing aliphatic or aromatic hydrocarbon such as bis(2-(carboxymethoxy)enyl)phenyl phosphine) or triphenylphosphine, or a carbon-phosphorus-containing heterocyclic compound such as triphenyl phosphine oxide, phosphaphenanthrene oxide, or a phosphazene, or a phosphorus-containing carbohydrate. The carbon precursor compound that does not include phosphorus may include any compounds known for providing a carbonaceous material by pyrolysis. Specific examples of the carbon precursor compound that does not include phosphorus may be carbohydrates such as sucrose, a furfuryl alcohol, divinylbenzene, a resorcinol-formaldehyde polymer, a phenol-formaldehyde polymer, acrylonitrile or polymers thereof, paratoluene sulfonic acid, and aromatic hydrocarbons (e.g., phenanthrene, anthracene, naphthalene, etc.), but are not limited thereto.

The carbon precursor solution may include the phosphorus-containing carbon precursor in an amount to provide phosphorus at greater than or equal to about 1 part by weight based on 100 parts by weight of carbon in the mesoporous carbon composite material. Without wishing to be bound by any theory, it is believed that in the obtained carbon composite material, the phosphorus may play a role of controlling the dispersity and the particle size of the metal to enhance the activity of the metal particles. In other words, by using the phosphorus-containing carbon precursor, the obtained carbon composite material may have nanoparticles distributed (or dispersed) on the mesoporous carbon.

The metal-containing salt may be a salt including copper (Cu), tin (Sn), zinc (Zn), titanium (Ti), silver (Ag), or palladium (Pd). The salt may be a chloride, a nitrate, a hydrate thereof, or a combination thereof. The carbon precursor solution may include the metal-containing salt in an amount to provide the metal at about 5 to about 45 parts by weight based on 100 parts by weight of carbon in the mesoporous carbon composite material.

The carbon precursor solution may include a carbonization catalyst. The carbonization catalyst may be an organic acid or an inorganic acid. For example, the carbonization catalyst may be sulfuric acid, nitric acid, phosphoric acid, acetic acid, formic acid, citric acid, paratoluene sulfonic acid, or a combination thereof, but is not limited thereto. The paratoluene sulfonic acid or the like may also act as a carbon precursor. The amount of carbonization catalyst is not particularly limited, but may be selected appropriately. For example, the amount of the carbonization catalyst may be greater than or equal to about 1 part by weight, for example, greater than or equal to about 5 parts by weight, based on 100 parts by weight of the carbon precursor, but is not limited thereto. When the carbonization catalyst may also act as the carbon precursor, the amount thereof may be adjusted so that the resulting carbon composite material may include the phosphorus and the metal within the aforementioned amount.

The solvent may be any solvent capable of dissolving or dispersing the carbon precursor compound that has or does not have the phosphorous, a metal salt compound, and a carbonization catalyst. Examples of available solvent may include, but are not limited to, water, acetone, methanol, ethanol, isopropyl alcohol, n-propyl alcohol, butanol, dimethyl acetamide, dimethyl formamide, dimethyl sulfoxide, N-methyl-2-pyrrolidone, tetrahydrofuran, tetrabutyl acetate, n-butyl acetate, m-cresol, toluene, ethylene glycol, gamma butyrolactone, hexafluoroisopropanol (HFIP), or a combination thereof. As used herein, the term “carbon precursor solution” includes a solution wherein the aforementioned components are dissolved or dispersed. According to example embodiments, the aforementioned components may be dissolved in the solvent. The amount of solvent is not particularly limited, but may be selected appropriately.

The method includes impregnating mesoporous silica with the carbon precursor solution. The impregnation may include mixing the mesoporous silica and the carbon precursor solution and stirring the same. Subsequently, the mesoporous silica impregnated with the carbon precursor solution is heat-treated to provide a carbon-silica composite. The heat treatment may include drying the impregnated mesoporous silica and carbonizing the carbon precursor. The drying condition is not particularly limited, but may be appropriately selected.

The drying may be performed at a temperature of greater than or equal to about 80° C., for example, at a temperature of greater than or equal to about 100° C., for greater than or equal to about 20 minutes, for example, greater than or equal to about 1 hour and less than or equal to about 10 hours, for example, less than or equal to about 8 hours, but is not limited thereto. The drying temperature and time may be adjusted so as to prevent substantial evaporation of the carbon precursor. The drying atmosphere is not particularly limited, and it may be performed under an air or inert atmosphere, or in vacuum. By the heat-treating during the drying process, the carbon precursor compound may form an oligomer.

The carbonization condition is not particularly limited as long as the carbon precursor is converted into a carbonaceous material (e.g., graphite or the like) by the pyrolysis. For example, the carbonization may be performed at a temperature of greater than or equal to about 600° C., for example, at a temperature of greater than or equal to about 700° C., or a temperature of greater than or equal to about 800° C. for greater than or equal to about 10 minutes, but is not limited thereto. The heating rate is not particularly limited during the carbonization, but may be appropriately selected. For example, the temperature may be increased in a time span of greater than or equal to about 1 minute, for example, at least about 1 hour, at least about 2 hours, at least about 3 hours, at least about 4 hours, or at least about 5 hours up to the target temperature of the carbonization. The carbonization atmosphere is not particularly limited, but may be performed under an air or non-oxidizing atmosphere. The silica-carbon composite is obtained by the carbonization. Subsequently, silica is removed from the silica-carbon composite thus obtained, for example, by contacting the same with a solution (e.g., an aqueous solution) capable of selectively dissolving the silica. Examples of the solution capable of selectively dissolving the silica may include, but are not limited to, a hydrofluoric acid solution, an alkaline metal or alkaline-earth metal solution (e.g., a sodium hydroxide solution or a potassium hydroxide solution), or the like. The concentration of the solution (or the aqueous solution) may be appropriately selected in light of the types of the solute included therein and is not particularly limited. For example, the solution (or the aqueous solution) may include a solute at greater than or equal to about 5 wt %.

The foregoing process of removing the silica may result in a mesoporous carbon composite material including mesoporous carbon, metal nanoparticles distributed on the carbon, and phosphorus. Details of the obtained mesoporous carbon composite material are the same as set forth above.

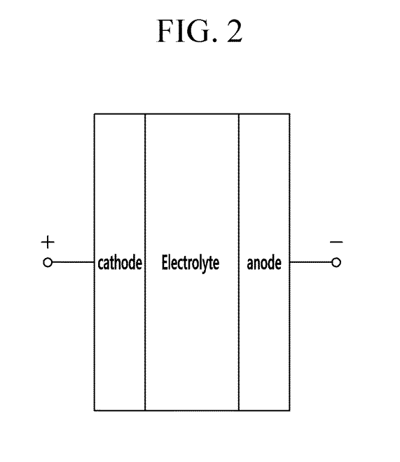

In example embodiments, an electronic device includes an electrode that includes the aforementioned mesoporous carbon composite material including a mesoporous carbon, metal nanoparticles distributed on the carbon, and phosphorus. The electronic device includes an anode, a cathode, and an electrolyte interposed between the anode and the cathode, wherein at least one of the anode and cathode is the electrode. As a non-limiting example, the case in which the electronic device is a capacitor is shown in FIG. 2.

When the electronic device is a capacitive deionization apparatus, the electrolyte may be a fluid containing a dissolved solid (e.g. ions) that flows through a flow path formed between a cathode and an anode.

The electronic device may further include an electrolyte including a halogen-containing salt such as sodium chloride. The electronic device may be various capacitors such as a pseudocapacitor or a supercapacitor, an energy storage device such as various batteries of a rechargeable battery, a fuel cell, or a capacitive deionization apparatus. The capacitive deionization apparatus may be applicable in an exterior water softener or a built-in water softener mounted in a washing machine, a steam cleaner, a humidifier, or the like.

As described above, the mesoporous carbon composite material may have pseudocapacitor characteristics (i.e., capacity according to faradaic electrochemical storage principle) besides that of the electrostatic storage principle such as electric double layer capacitance, so may have significantly improved capacity compared to the conventional carbon electrode such as one including activated carbon. Accordingly, an electronic device having high capacity may be provided, and the high capacity may be accomplished even with a small-volume electrode. Thus,the final device may have a reduced volume.

Hereinafter, non-limiting examples of example embodiments are described. However, the scope of the present disclosure is not limited to these examples.

### EXAMPLES

### Reference Example

### Production of Mesoporous Carbon Composite Material

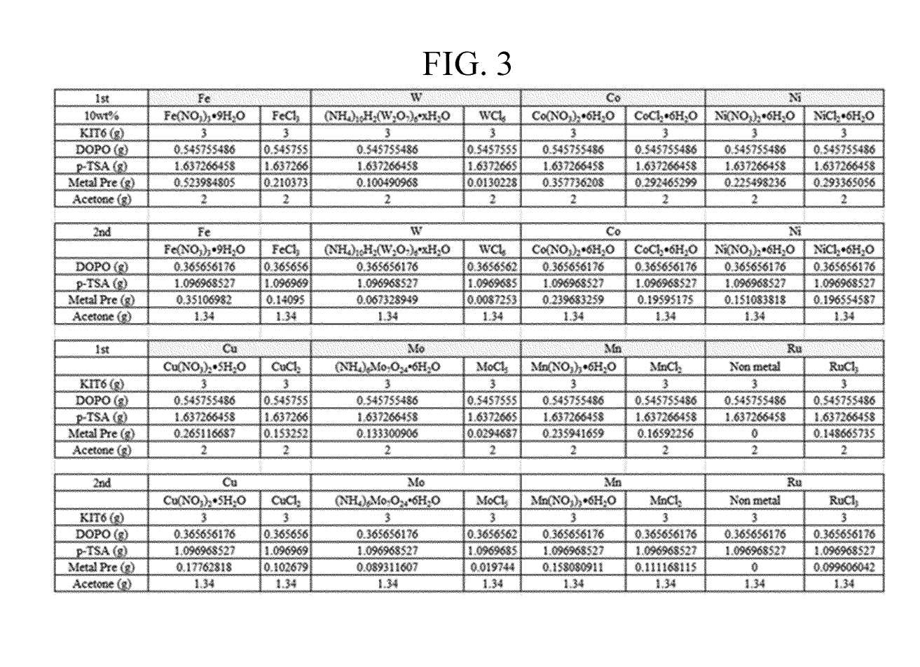

Mesoporous silica of KIT-6, a phosphorus-containing carbon precursor of 9-oxa-10-phosphophenanthrene-10-oxide (DOPO), a metal salt of copper chloride or copper nitrate hydrate, a carbonization catalyst of paratoluene sulfonic acid (p-TSA), and a solvent of acetone are used in amounts set forth in FIG. 3.

The mesoporous silica, the DOPO, and the copper chloride (or the copper nitrate hydrate) are mixed, and acetone and paratoluene sulfonic acid are added thereto and dissolved. The obtained mixture is stirred to impregnate the mesoporous silica with a carbon precursor solution. The mesoporous silica impregnated with the precursor solution is heat-treated in an oven at 160° C. for 6 hours. According to the heat treatment, a dark-colored powder is obtained. The obtained powder is carbonized and heat-treated at 900° C. for 2 hours under a nitrogen gas atmosphere to provide a carbon-silica composite. The obtained carbon silica composite is immersed in a hydrofluoric acid solution to provide a mesoporous carbon composite material (Cu—P—OMC) in which copper nanoparticles are distributed on the surface.

The obtained mesoporous carbon composite material undergoes a nitrogen isothermal adsorption evaluation to provide a specific surface area, an average pore size, and a pore volume. The results are shown in Table 1.

The obtained mesoporous carbon composite material undergoes energy dispersive X-ray spectrophotometry (EDS), and the results are shown in Table 2 (described later).

### Comparative Example 1

Activated carbon is used as a carbon material in Comparative Example 1.

### Comparative Example 2

A carbon material (C-OMC) is prepared in accordance with the same procedure as in Reference Example 1, except that a carbon precursor including no phosphorus is used instead of the metal salt.

### Comparative Example 3

A carbon material (P50-OMC) is prepared in accordance with the same procedure as in Reference Example 1, except that a carbon precursor including no phosphorus is used instead of the metal salt.

The obtained mesoporous carbon composite material undergoes a nitrogen isothermal adsorption evaluation, and a specific surface area, an average pore size, and a pore volume are obtained therefrom. The results are shown in Table 1.

### Comparative Example 4

A carbon material (Cu—OMC) is prepared in accordance with the same procedure as in Reference Example 1, except that a carbon precursor including no phosphorus is used.

### Comparative Example 5

A carbon material (P100-OMC) is prepared in accordance with the same procedure as in Reference Example 1, except that a phosphorus-containing carbon precursor is used instead of the metal salt.

### Comparative Example 6 to 12

A mesoporous carbon composite material is obtained in accordance with the same procedure as in Reference Example 1, except that metal salts of an iron salt (Comparative Example 6, Fe—OMC), a tungsten salt (Comparative Example 7, W—OMC), a manganese salt (Comparative Example 8, Mn—OMC), a nickel salt (Comparative Example 10, Ni—OMC), a molybdenum salt (Comparative Example 9, Mo—OMC), a ruthenium salt (Comparative Example 11, Ru—OMC), and a cobalt salt (Comparative Example 12, Co—OMC) are respectively used in the amounts shown in Table 1.

The obtained mesoporous carbon composite material undergoes a nitrogen isothermal adsorption evaluation, and a specific surface area, an average pore size, and a pore volume are obtained therefrom. The results are shown in Table 1. In Table 1, CE is an abbreviation for Comparative Example and RE is an abbreviation for Reference Example.

TABLE 1

| | CE 3 | CE 6 | CE 7 | RE 1 | CE 8 | CE 9 | CE 10 | CE 11 | CE 12 |
|---|---|---|---|---|---|---|---|---|---|
| Metal | — | Fe | W | Cu | Mn | Mo | Ni | Ru | Co |
| S_{BET} (cm²/g) | 810 | 874 | 610 | 638 | 887 | 734 | 611 | 741 | 650 |
| D_{P} (nm) | 3.6 | 3.6 | 3.2 | 3.6 | 3.5 | 3.6 | 3.2 | 3.6 | 3.6 |
| Vₜₒₜₐₗ (cm³/g) | 1.44 | 1.16 | 1.12 | 0.92 | 1.46 | 1.17 | 1.04 | 1.01 | 0.87 |

From the results shown in Table 1, it is confirmed that metal nanoparticles are present on carbon without remarkably influencing the structural properties of mesoporous carbon (e.g., pore size, total pore volume).

TABLE 2

Cu

| | Weight % | Atomic % |
|---|---|---|
| C K | 64.26 | 80.48 |
| O K | 10.64 | 10.00 |
| P K | 8.13 | 3.95 |
| S K | 6.67 | 3.13 |
| Cu | 10.29 | 2.44 |

From the results shown in Table 2, it is confirmed that a plurality of copper particles are distributed on the surface of mesoporous carbon.

### Experimental Example 1

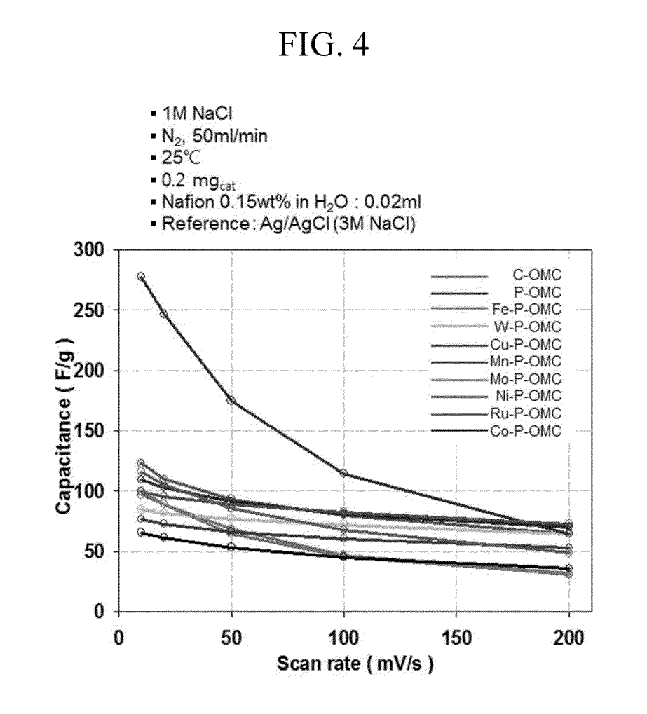

An electrode is fabricated with each carbon (composite) material obtained from Reference Example 1, Comparative Example 2, Comparative Example 3, and Comparative Examples 5 to 11 according to the following methods, and undergoes cyclic voltammetry analysis under a three-electrode system, and the results are shown in the following Table 3 and FIG. 4.

10 mg of a mesoporous carbon composite material is mixed with 1 mL of ethanol and completely dispersed using an ultrasonic device. 20 μL of the obtained dispersion solution is coated on a rotation disc electrode and dried at room temperature, and then is coated with a 20 μL (0.15 wt %) solution in which Nafion (manufactured by Aldrich) is dispersed in distilled water and dried at room temperature again to provide an electrode. The electrode (0.19625 cm²) is used as a working electrode; a Pt electrode is used a counter electrode; and Ag/AgCl (3M NaCl) is used as a standard electrode. It is measured under the condition at 25° C. while continuously injecting nitrogen (50 cc/min) into a 1 M NaCl solution.

TABLE 3

| | | Capacity measured at various scan rates (F/g) | | | | |
|---|---|---|---|---|---|---|
| | | 10 mV/s | 20 mV/s | 50 mV/s | 100 mV/s | 200 mV/s |
| Comparative | C-OMC | 122.8636 | 109.7331 | 93.1503 | 80.0332 | 64.2913 |
| Example 2 | | | | | | |
| Comparative | P50-OMC | 109.3100 | 102.8083 | 91.0391 | 80.7631 | 70.4666 |
| Example 3 | | | | | | |
| Comparative | Fe—P-OMC | 99.8544 | 88.9161 | 68.4985 | 46.8171 | 31.6213 |
| Example 6 | | | | | | |
| Comparative | W—P-OMC | 84.3804 | 81.5868 | 76.8041 | 71.7864 | 64.5466 |
| Example 7 | | | | | | |
| Reference | Cu—P-OMC | 277.7190 | 246.7610 | 174.6359 | 114.3660 | 64.4578 |
| Example 1 | | | | | | |
| Comparative | Mn—P-OMC | 99.4785 | 95.5932 | 89.2175 | 82.5489 | 72.6768 |
| Example 8 | | | | | | |
| Comparative | Mo—P-OMC | 96.7484 | 88.9726 | 64.4794 | 45.6930 | 30.8194 |
| Example 9 | | | | | | |
| Comparative | Ni—P-OMC | 76.5959 | 72.6624 | 66.3418 | 60.3945 | 52.8403 |
| Example 10 | | | | | | |
| Comparative | Ru—P-OMC | 115.9606 | 105.3494 | 85.6583 | 67.8809 | 48.7303 |
| Example 11 | | | | | | |
| Comparative | Co—P-OMC | 65.2158 | 61.2654 | 53.2943 | 44.9714 | 35.7356 |
| Example 12 | | | | | | |

From the results shown in FIG. 4 and Table 2, it is confirmed that the carbon composite material according to Reference Example 1 including Cu nanoparticles and phosphorus has significantly higher capacity than the capacity of the electrode including the mesoporous carbon material (C-OMC), the phosphorus-containing mesoporous carbon material, and the mesoporous carbon material containing phosphorus and a metal such as Fe (except Cu).

### Example 1

A mesoporous carbon composite material (Cu5-P—OMC) is obtained in accordance with the same procedure as in Reference Example 1, except for using KIT-6, 9-oxa-10-phosphophenanthrene-10-oxide (DOPO), copper chloride, paratoluene sulfonic acid (p-TSA), and acetone. In the obtained mesoporous carbon composite material, the weight ratio of carbon to copper is 95:5.

### Example 2

A mesoporous carbon composite material (Cu10-P—OMC) is prepared in accordance with the same procedure as in Reference Example 1, except that KIT-6, 9-oxa-10-phosphophenanthrene-10-oxide (DOPO), copper chloride, paratoluene sulfonic acid (p-TSA), and acetone are used. In the obtained mesoporous carbon composite material, the weight ratio of carbon to copper is 90:10.

### Example 3

### Production of Mesoporous Carbon Composite Material

A mesoporous carbon composite material (Cu20-P—OMC) is obtained in accordance with the same procedure as in Reference Example 1, except that KIT-6, 9-oxa-10-phosphophenanthrene-10-oxide (DOPO), copper chloride, paratoluene sulfonic acid (p-TSA), and acetone are used. In the obtained mesoporous carbon composite material, the weight ratio of carbon to copper is 80:20.

### Example 4

A mesoporous carbon composite material (Cu30-P—OMC) is obtained in accordance with the same procedure as in Reference Example 1, except that KIT-6, 9-oxa-10-phosphophenanthrene-10-oxide (DOPO), copper chloride, paratoluene sulfonic acid (p-TSA), and acetone are used. In the obtained mesoporous carbon composite material, the weight ratio of carbon to copper is 70:30.

### Example 5

A mesoporous carbon composite material (Cu-P100-OMC) is obtained in accordance with the same procedure as in Reference Example 1, except that KIT-6, 9-oxa-10-phosphophenanthrene-10-oxide (DOPO), copper chloride, paratoluene sulfonic acid (p-TSA), and acetone are used. In the obtained mesoporous carbon composite material, the weight ratio of carbon to copper is 90:10.

### Experimental Example 2

For the mesoporous carbon composite materials obtained from Examples 1 to 4, a nitrogen isothermal adsorption evaluation is performed to provide a specific surface area, an average pore size, and a pore volume. The results are shown in Table 4.

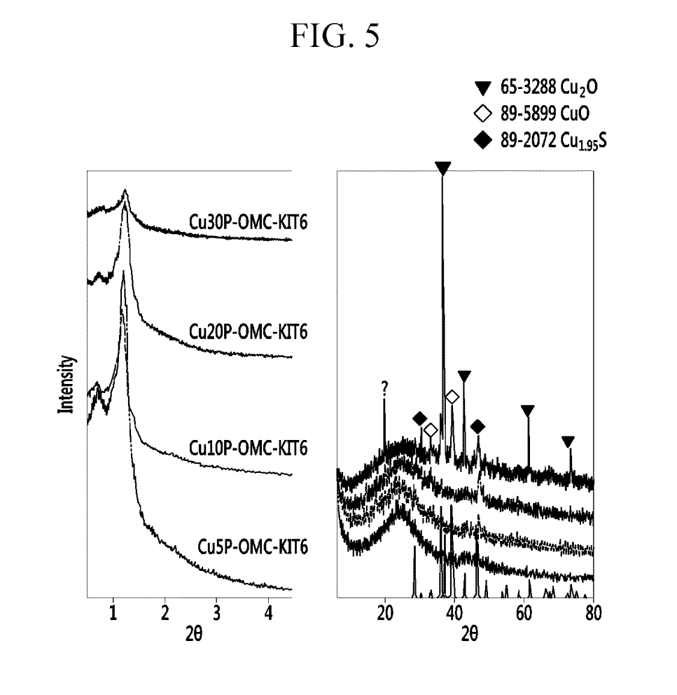

For the mesoporous carbon composite materials obtained from Examples 1 to 4, X-ray diffraction spectrophotometry is performed, and the results are shown in FIG. 5.

TABLE 4

| | Example 1 | Example 2 | Example 3 | Example 4 |
|---|---|---|---|---|
| Composition | Cu5P-OMC | Cu10P-OMC | Cu20P-OMC | Cu30P-OMC |
| S_{BET} (cm²/g) | 718.50 | 729.35 | 480.07 | 455.38 |
| D_{P} (nm) | 3.9 | 3.8 | 3.7 | 3.8 |
| Vₜₒₜₐₗ (cm³/g) | 1.16 | 1.03 | 0.76 | 0.88 |

From the results shown in Table 4, it is confirmed that the carbon composite materials according to Examples 1 to 4 have an average pore diameter of less than or equal to about 4 nm and a pore volume of less than or equal to about 2 cm³/g while having an appropriate specific surface area.

From the results shown in FIG. 5, it is confirmed that the mesoporous carbon composite materials according to Examples 1 to 4 include an ordered mesoporous carbon and include a crystalline copper oxide.

### Experimental Example 3

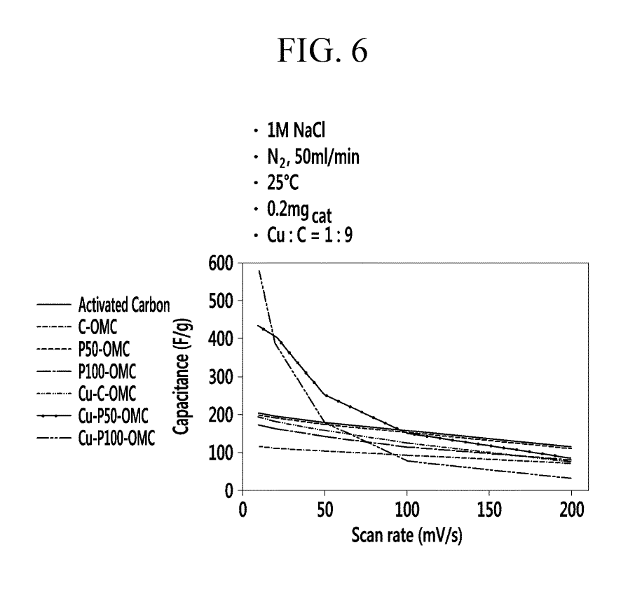

The (mesoporous) carbon (composite) materials according to Comparative Examples 1 to 5 and the mesoporous carbon composite materials according to Example 2 and Example 5 are used as a working electrode, and undergo a voltammetry analysis under the three-electrode system in accordance with the same procedure as in Experimental Example 1, and the results are shown in FIG. 6 and Table 5.

TABLE 5

| | | Electrode capacity (F/g) | | | |
|---|---|---|---|---|---|
| | Electrode | 10 mV/ | 20 mV/ | 50 mV/ | 100 mV/ |
| | composition | s | s | s | s |
| Comparative | Activated | 203.9 | 194.8 | 175.8 | 150.8 |
| Example 1 | carbon | | | | |
| Comparative | OMC | 113.1 | 108.9 | 100.6 | 89.9 |
| Example 2 | | | | | |
| Comparative | P50-OMC | 198.8 | 189.1 | 169.3 | 143.9 |
| Example 3 | | | | | |
| Comparative | Cu-OMC | 192.5 | 180.9 | 151.6 | 118.6 |
| Example 4 | | | | | |
| Comparative | P100-OMC | 170 | 160 | 138 | 114 |
| Example 5 | | | | | |
| Example 2 | Cu-P50-OMC | 426.4 | 397.9 | 247.3 | 150.7 |
| Example 5 | Cu-P100-OMC | 568.5 | 386.2 | 171.5 | 79.3 |

From the results shown in FIG. 6 and Table 5, it is confirmed that phosphorus-containing mesoporous carbon composite materials according to the examples including metal nanoparticles in the mesoporous carbon may have a significantly higher capacity than the materials according to the comparative examples.

Without wishing to be bound by any particular theory, it is believed that the copper (Cu) is not activated in the composite material according to Comparative Example 4 that does not involve phosphorous (P) and thus the capacity thereof is similar to that of the carbon material according to Comparative Example 2 that does not include the copper (Cu). On the contrary, the carbon composite materials according to Example 2 and Example 5 including both Cu and P may have significantly improved capacity.

### Experimental Example 4

### Capacity Change Depending on the Amount of the Copper (Cu)

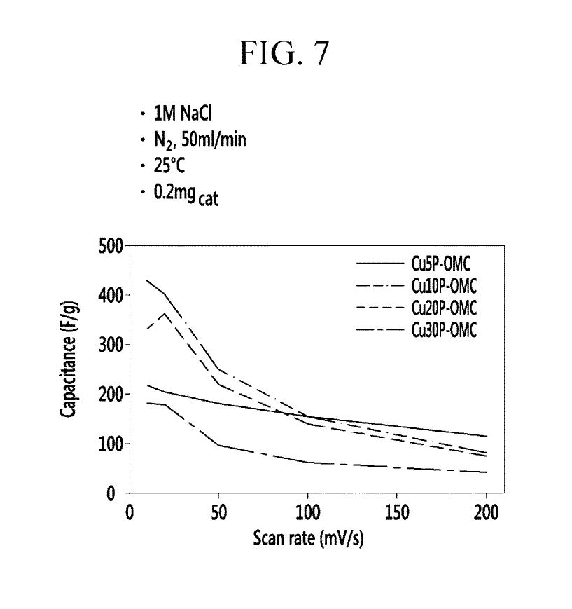

Each of the mesoporous carbon composite materials of Examples 1 to 4 is used as a working electrode and subjected to the voltammetry analysis under the three-electrode system in accordance with the same procedure as in Experimental Example 1, and the results are shown in FIG. 7 and Table 6.

TABLE 6

| | | Electrode capacity (F/g) | | | |
|---|---|---|---|---|---|
| | Electrode | 10 mV/ | 20 mV/ | 50 mV/ | 100 mV/ |
| | composition | s | s | s | s |
| Example 1 | Cu5-P-OMC | 216 | 2014.1 | 179.6 | 152.1 |
| Example 2 | Cu10-P-OMC | 426.4 | 397.9 | 247.3 | 150.7 |
| Example 3 | Cu20-P-OMC | 329.8 | 357.4 | 216.3 | 136.8 |
| Example 4 | Cu30-P-OMC | 177.6 | 174.2 | 95.5 | 61 |

The results shown in FIG. 7 and Table 6 confirm that the mesoporous carbon composite materials according to the examples may have very high capacity according to the Cu amount.

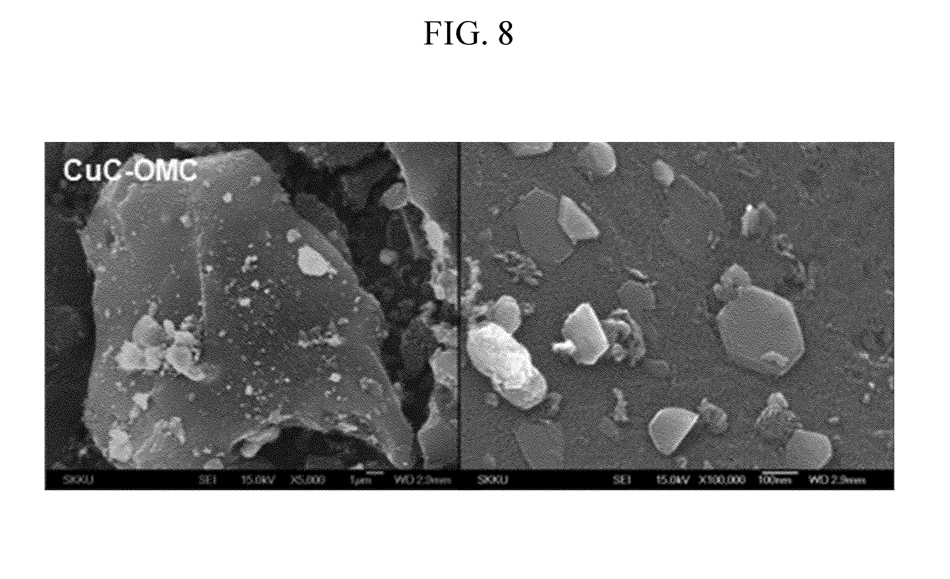

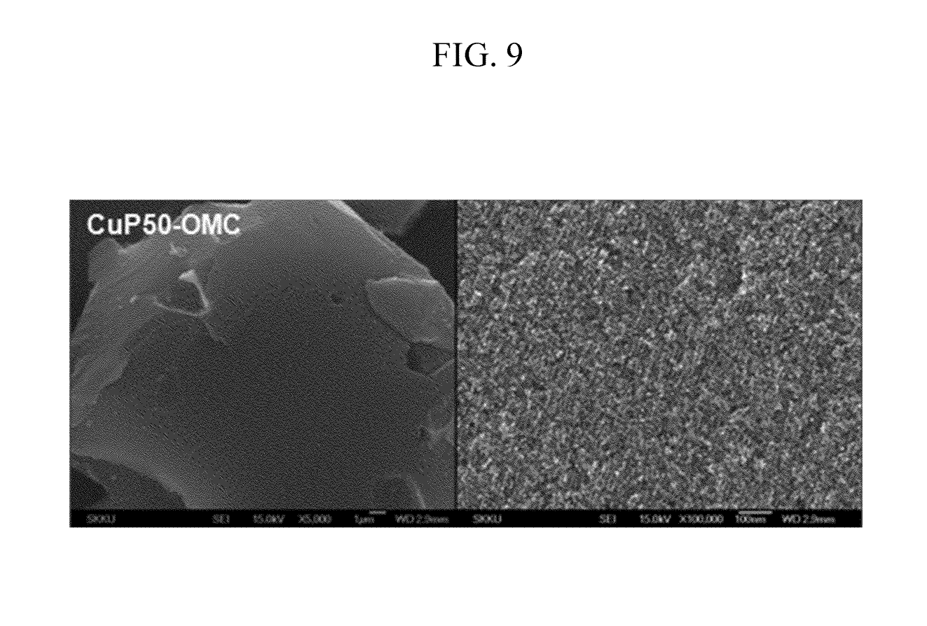

### Experimental Example 5

[1] A scanning electron microscopic analysis is made for the carbon composite material according to Comparative Example 4 and the carbon composite material according to Example 2, and the results are shown in FIG. 8 (Comparative Example 4) and FIG. 9 (Example 2).

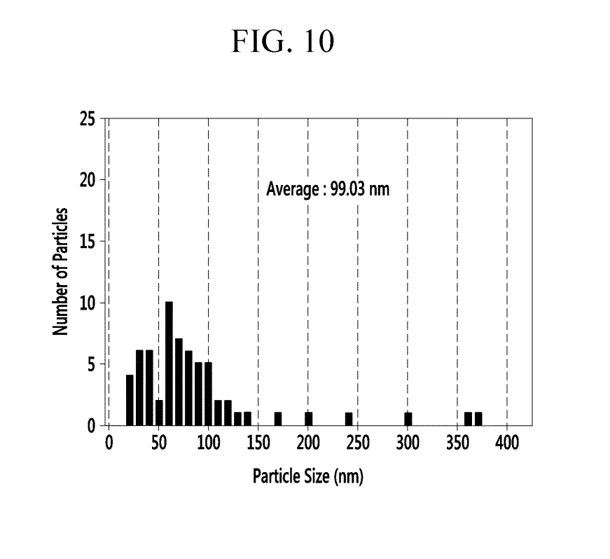

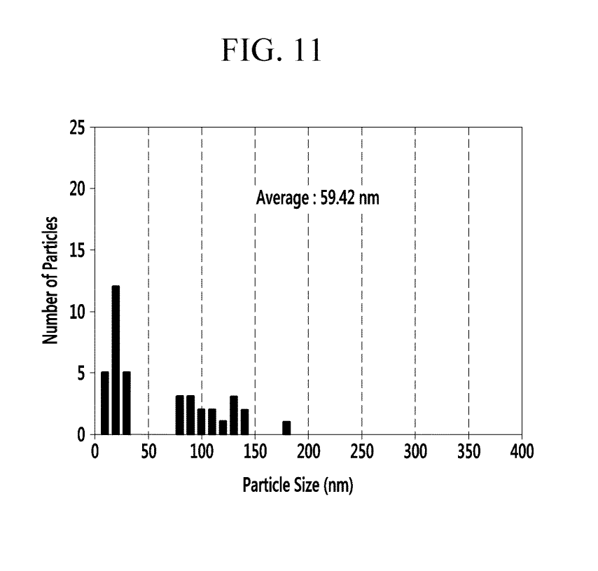

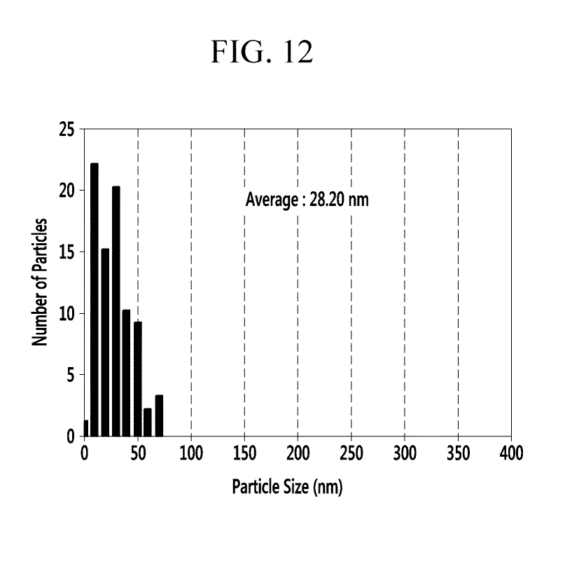

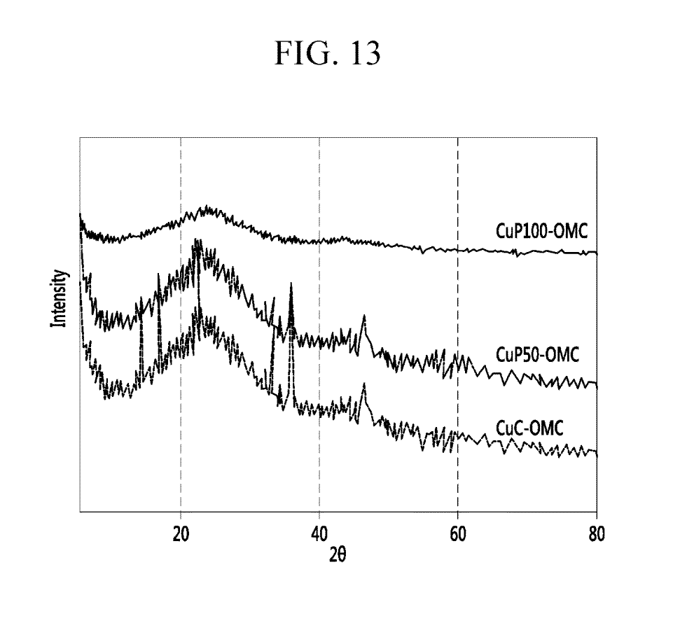

The results shown in FIG. 8 and FIG. 9 confirm that the carbon composite material according to Example 2 has a significantly smother surface than the carbon composite material according to Comparative Example 4.

[2] A transmission electron microscopic analysis is made for the carbon composite material according to Comparative Example 4 and the carbon composite materials according to Example 2 and Example 5. The size distributions of metal particles obtained from the obtained transmission electron microscopic photographs are shown in FIG. 10 (Comparative Example 4), FIG. 11 (Example 2), and FIG. 12 (Example 5). The results shown in FIG. 10, FIG. 11, and FIG. 12 confirm that in the composite material of Comparative Example 4 without having the phosphorous (P), many metal particles having a large size is included; on the other hand, in the composite materials of Example 2 and Example 5, the average size of the metal particles is small, and also the number of metal particles having a large size is significantly decreased.

[3] An XRD analysis is made for the carbon composite material of Comparative Example 4 and the carbon composite materials of Example 2 and Example 5, and the results are shown in FIG. 13. The results of FIG. 13 confirmed that using the phosphorus-containing carbon precursor may result in a smaller size of metal particles distributed on the mesoporous carbon. Without wishing to be bound by any theory, it is believed that the production of the nano-sized metal nanoparticles may significantly contribute to the capacity improvement of the carbon composite material.

While some example embodiments have been particularly shown and described, it will be understood by one of ordinary skill in the art that variations in form and detail may be made therein without departing from the spirit and scope of the claims.

1. A mesoporous carbon composite material comprising:
mesoporous carbon;
a plurality of metal nanoparticles distributed on the mesoporous carbon; and
phosphorus (P) on the mesoporous carbon.

2. The mesoporous carbon composite material of claim 1, wherein the mesoporous carbon is ordered mesoporous carbon.

3. The mesoporous carbon composite material of claim 1, wherein the metal includes one of copper (Cu), tin (Sn), zinc (Zn), titanium (Ti), silver (Ag), palladium (Pd), and a combination thereof.

4. The mesoporous carbon composite material of claim 1, wherein the metal nanoparticles have an average particle size of less than or equal to about 90 nm.

5. The mesoporous carbon composite material of claim 1, wherein the amount of the metal nanoparticles is about 3 to about 45 parts by weight based on 100 parts by weight of the mesoporous carbon.

6. The mesoporous carbon composite material of claim 1, wherein the composite material has an average pore diameter of less than or equal to about 10 nm, and has a total pore volume of less than or equal to about 1.5 cm³/g.

7. The mesoporous carbon composite material of claim 1, wherein the carbon composite material has capacitance of greater than or equal to about 200 F/g at a scan rate of 10 mV/s.

8. A method of producing a mesoporous carbon composite material comprising mesoporous carbon, a plurality of metal nanoparticles distributed on the mesoporous carbon, and phosphorus on the mesoporous carbon, which comprises:
preparing a carbon precursor solution including a phosphorus-containing carbon precursor, a metal-containing salt, a solvent, and optionally a carbonization catalyst;
impregnating a mesoporous silica with the carbon precursor solution;
forming a carbon-silica composite by heat-treating the mesoporous silica impregnated with the carbon precursor solution; and
removing silica from the carbon silica composite.

9. The method of claim 8, wherein the phosphorus-containing carbon precursor includes one of a phosphorus-containing aliphatic or aromatic hydrocarbon, a carbon-phosphorus-containing heterocyclic compound, a phosphorus-containing carbohydrate, and a combination thereof.

10. The method of claim 8, wherein the metal-containing salt is a salt including one of copper (Cu), tin (Sn), zinc (Zn), titanium (Ti), silver (Ag), palladium (Pd), and a combination thereof.

11. The method of claim 8, wherein
the carbon precursor solution includes the carbonization catalyst, and the carbonization catalyst is one of an organic acid and an inorganic acid.

12. The method of claim 8, wherein
the carbon precursor solution includes the metal-containing salt in such an amount that the mesoporous carbon composite material includes the metal nanoparticles in an amount of about 3 to about 45 parts by weight per 100 parts by weight of the mesoporous carbon, and
the carbon precursor solution includes the phosphorus-containing carbon precursor in such an amount that the mesoporous carbon composite material includes phosphorus of greater than or equal to about 1 part by weight per 100 parts by weight of carbon.

13. The method of claim 8, wherein the heat treatment includes drying the impregnated mesoporous silica and carbonizing the carbon precursor solution.

14. The method of claim 8, wherein the removing the silica from the carbon-silica composite includes using a solvent capable of selectively dissolving silica in the carbon-silica composite.

15. An electronic device comprising:
an electrode including a mesoporous carbon composite material, the mesoporous carbon composite material including mesoporous carbon, a plurality of metal nanoparticles distributed on the mesoporous carbon, and phosphorus on the mesoporous carbon.

16. The electronic device of claim 15, wherein the metal includes one of copper (Cu), tin (Sn), zinc (Zn), titanium (Ti), silver (Ag), palladium (Pd), and a combination thereof.

17. The electronic device of claim 15, wherein
the mesoporous carbon is ordered mesoporous carbon, and
the mesoporous carbon composite material has an average pore diameter of less than or equal to about 10 nm, and has a total pore volume of less than or equal to about 1.5 cm³/g.

18. The electronic device of claim 15, wherein the electrode has capacitance of greater than or equal to about 200 F/g at a scan rate of 10 mV/s.

19. The electronic device of claim 15, wherein the electrolyte includes a halogen-containing salt.

20. The electronic device of claim 15, wherein the electronic device is one of an energy storage device and a capacitive deionization apparatus.
